(19) United States
(12) Patent Application Publication
(10) Pub. No.: US 2006/0206338 A1
(43) Pub. Date: Sep. 14, 2006

(54) Device and method for providing contents

(76) Inventors: Katsunori Takahashi, Tokyo (JP); Hideaki Takeda, Tokyo (JP)

Correspondence Address: BRINKS HOFER GILSON & LIONE, P.O. BOX 10395, CHICAGO, IL, 60610, US

(21) Appl. No.: 11/352,451

(22) Filed: Feb. 10, 2006

(30) Foreign Application Priority Data
Feb. 16, 2005 (JP) 2005-039889

(51) Int. Cl. G10L 21/00

(52) U.S. Cl. 704/275

(57) ABSTRACT

There is provided a content providing device which enables easy and quick review of relevant information of contents. The content providing device 100 includes a control unit 10 which carries out a provisional process of presenting a content, a speech recognizing engine 16 which recognizes a speech pattern collected by a microphone 3 in response to a depression of a speech switch 20 during the provisional process of presenting the content, a readout control section 12 which carries out a process which reads out a title of the content based upon a speech recognition result, and a speech synthesizing engine 18 which carries out a process which synthesizes a speech pattern in response to the readout process, and reproduces a synthesized speech pattern from a speaker 40.

### BACKGROUND OF THE INVENTION

1. Field of the Invention

The present invention relates to a device and a method which provide various types of contents.

2. Description of the Related Art

There are conventional onboard navigation devices which have a function to provide various types of contents such as news articles and location information (refer to Japanese Laid-Open Patent Publication (Kokai) No. 2004-309183, for example). Moreover, some of these navigation devices which provide contents show on a display as well as read and acoustically reproduce contents in consideration of a user driving a vehicle.

However, with the conventional navigation devices which provide contents, if the user wants to review relevant information associated with the content such as a title of the content, the user has to carry out operations such as waiting until the end of a readout process, causing the navigation device to show a list of contents on a display, selecting some of the contents, causing the navigation device to carry out the readout process again for the contents selected, stopping the readout process, and causing the navigation device to show a title of the content on the display. Therefore, the user cannot easily and quickly review relevant information of contents.

### SUMMARY OF THE INVENTION

An object of the present invention is to solve the above problem, and to provide a content providing device which enables an easy and quick review of relevant information associated with contents, such as reproducible contents capable of being embedded within a carrier signal or capable of being stored on a storage media.

There is provided a content providing device according to the present invention including content provisional processing means which carries out a provisional process of presenting a content, and relevant descriptive information reading means which reads and acoustically reproduces relevant information describing the content during the execution of the provisional process of presenting the content by the content provisional processing means.

According to this configuration, it is possible to provide the content as well as to acoustically reproduce the relevant descriptive information describing the content, and thus the user can easily and quickly review the relevant information describing the content.

Moreover, there is provided the content providing device according to the present invention further including readout instructing means which instructs the relevant information reading means to read the relevant information describing the content, where the relevant information reading means reads and acoustically reproduces the relevant information of the content according to the instruction of the readout instructing means.

According to this configuration, it is possible to acoustically reproduce the relevant information describing the content according to the instruction of a user.

Moreover, there is provided the content providing device according to the present invention further including speech recognizing means which recognizes a speech pattern, where the relevant information reading means reads and acoustically reproduces relevant information of the content relating to the speech recognized by the speech recognizing means.

According to this configuration, it is possible to acoustically reproduce the relevant information of the content according to the instruction of a user by means of a speech pattern.

Moreover, there is provided the content providing device according to the present invention where the content provisional processing means suspends the provisional process of the content while the relevant information reading means is reading and acoustically reproducing the relevant information of the content.

With this configuration, the user can easily listen to the speech reciting the relevant information describing the content.

Moreover, there is provided the content providing device according to the present invention where the content provisional processing means resumes the provisional process prior to a portion in the content which was being provided upon the suspension.

With this configuration, if the content is character information, for example, the provisional process can be resumed from a top of a paragraph prior to a portion which was being provided upon the suspension, and thus the user can easily understand the content even if the provisional of the content is suspended.

Moreover, there is provided the content providing device according to the present invention where the content provisional processing means reduces a sound volume of the provisional process of the content while the relevant information reading means is reading and acoustically reproducing the relevant information describing the content.

With this configuration, the user can easily listen to the speech reciting the relevant information describing the content.

Moreover, there is provided the content providing device according to the present invention further including relevant information displaying means which shows an image corresponding to the relevant information of the content while the relevant information reading means is reading and acoustically reproducing the relevant information of the content.

Moreover, there is provided the content providing device according to the present invention where the content provisional processing means carries out a provisional process of presenting a content in a navigation device, and the relevant information reading means reads and acoustically reproduces title information of the content in the navigation device.

Moreover, there is provided the content providing device according to the present invention where the content within the navigation device is either tourist guidance information or location information.

Moreover, there is provided the content providing device according to the present invention where if the content of the navigation device is the location information, the relevant information reading means reads and acoustically reproduces at least any one of a facility name, an address, a zip code, a telephone number, and date and time of creation of information.

Moreover, there is provided the content providing device according to the present invention where the content provisional processing means carries out a provisional process of presenting a content recorded in a recording medium, and the relevant information reading means reads and acoustically reproduces title information of the content recorded in the recording medium.

Moreover, there is provided the content providing device according to the present invention where the content provisional processing means carries out a provisional process of presenting a body of an electronic mail within an electronic mail receiving device, and the relevant information reading means reads and acoustically reproduces at least any one of a title, a sender, date and time of reception, and a presence of an attachment of the electronic mail.

Moreover, there is provided the content providing device according to the present invention where the content provisional procession means carries out a provisional process of presenting a broadcast within a broadcast receiving device, and the relevant information reading means reads and acoustically reproduces a title of the broadcast.

There is provided a content providing method according to the present invention including a step of carrying out a provisional process of presenting a content, and a step of reading and acoustically reproducing information relevant to the content during the execution of the provisional process of presenting the content.

According to the present invention, it is possible to provide a content as well as to acoustically reproduce relevant information of the content, and thus a user can easily and quickly review the relevant information of the content.

### BRIEF DESCRIPTION OF THE DRAWINGS

FIG. 1 is a diagram showing a configuration of a first content providing device;

FIG. 2 is a diagram showing an example of content data;

FIG. 3 is a flowchart showing an operation of the first content providing device;

FIG. 4 is a diagram showing an example of a readout-specific recognition dictionary;

FIG. 5 is a diagram showing a configuration of a second content providing device;

FIG. 6 is a diagram showing a configuration of a third content providing device;

FIG. 7 is a flowchart showing an operation of the third content providing device;

FIG. 8 is a diagram showing a configuration of a fourth content providing device;

FIG. 9 is a flowchart showing an operation of the fourth content providing device;

FIG. 10 is a diagram showing a configuration of a fifth content providing device; and

FIG. 11 is a flowchart showing an operation of the fifth content providing device.

### DETAILED DESCRIPTION OF THE PREFERRED EMBODIMENTS

A specific description will now be given of an embodiment of the present invention with reference to drawings.

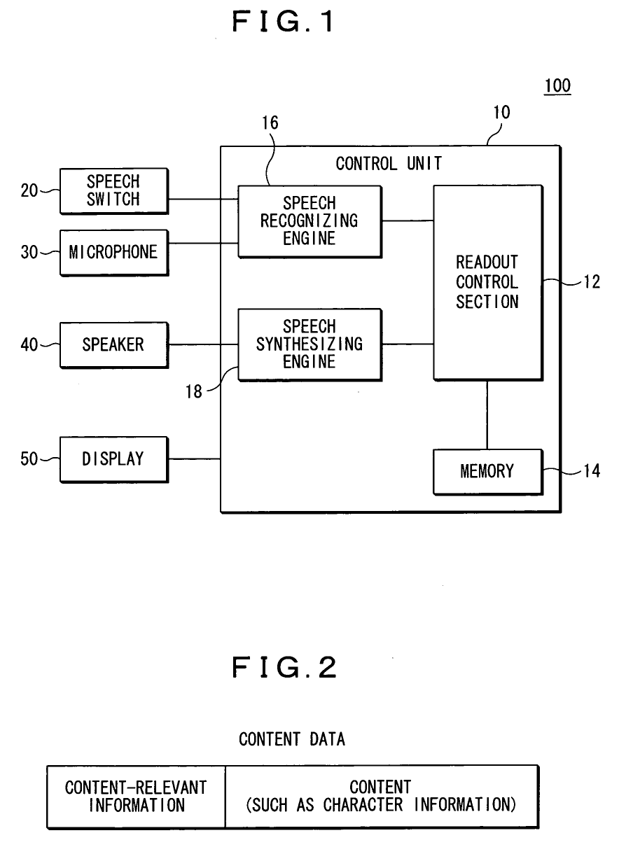

FIG. 1 shows a configuration of a content providing device. The content providing device 100 shown in FIG. 1 is a navigation device installed upon a vehicle, for example, and as illustrated includes a control unit 10, a speech switch 20, a microphone 30, a speaker 40, and a display 50. The control unit 10 may further include a readout control section 12, a memory 14, a speech recognizing engine 16, and a speech synthesizing engine 18.

The control unit 10 carries out a process which reads content data stored in the memory 14 or the like, and provides a user with contents. FIG. 2 shows an example of the content data. The content data shown in FIG. 2 includes a content itself such as character information, or data related to textual, audio, video, or other content, and information relevant to the content such as a title of the content. For example, if the content is character information, the control unit 10 carries out a process which reads out the character information, and reproduces sounds from the speaker 40.

The readout control section 12 in the control unit 10 carries out a process which reads relevant information of a content contained in content data. The speech recognizing engine 16 incorporates a speech recognition dictionary, and recognizes a speech pattern collected by the microphone 30 based upon the speech recognition dictionary when the speech switch 20 is depressed. The speech synthesizing engine 18 carries out a process which synthesizes a speech corresponding to the readout process by the readout control section 12, and reproduces the synthesized speech from the speaker 40.

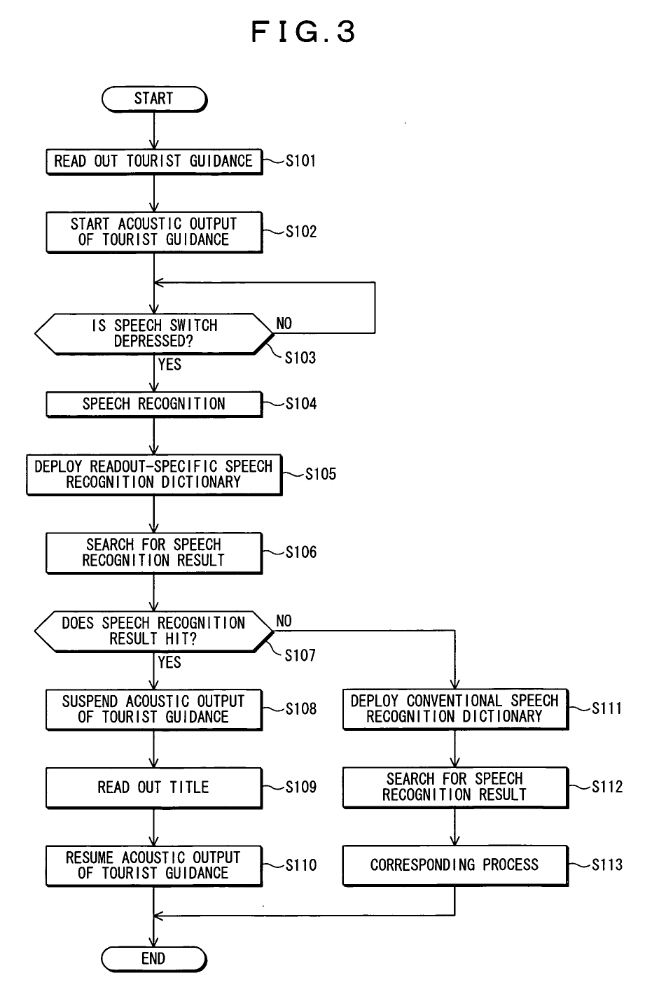

A description will now be given of an operation of the content providing device 100 with reference to a flowchart. FIG. 3 is a flowchart showing the operation of the content providing device 100. It should be noted that the following description will be given of a case where the content providing device 100 has a function to acoustically provide a tourist guidance which is a content, and the content-relevant information is a title of the tourist guidance, for example.

The control unit 10 starts a process which reads content data relating to a tourist guidance stored in the memory 14 or the like (S101), and reproduces sounds of the tourist guidance from the speaker 40 (S102). The control unit 10 then determines whether the speech switch 20 is depressed or not (S103).

If a user is depressing the speech switch 20, the speech recognizing engine 16 recognizes a speech pattern collected by the microphone 30 (S104). The speech recognizing engine 16 then deploys an incorporated readout-specific speech recognition dictionary (S105).

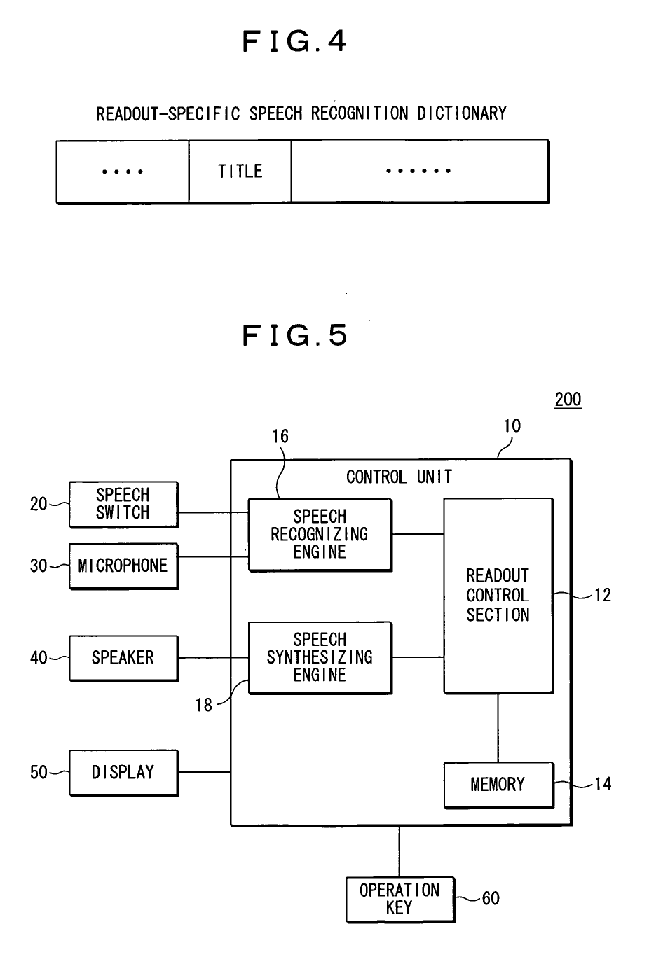

The speech recognizing engine 16 then searches for a speech recognition result obtained in the step S104 (S106), and determines whether the speech recognition results in a “hit” or match in the readout-specific speech recognition dictionary (S107). FIG. 4 is a diagram showing an example of the readout-specific speech recognition dictionary. As shown in FIG. 4, the readout-specific speech recognition dictionary includes information corresponding to “title” which is a speech pattern to be recognized. The speech recognizing engine 16 determines that the speech recognition result receives a “hit” if the speech recognition result is “title” which coincides with the information in the readout-specific speech recognition dictionary.

If the speech recognition result receives a “hit” from the readout-specific speech recognition dictionary, in other words, if the speech recognition result is “title”, the control unit 10 suspends the process which reproduces the sounds of the tourist guidance from the speaker 40 (S108).

The readout control section 12 then carries out a process which reads title information in content-relevant information included in the content data subjected to the acoustic reproduction of the tourist guidance. The speech synthesizing engine 18 carries out a process which synthesizes a speech corresponding to the readout process by the readout control section 12, and reproduces the synthesized speech from the speaker 40 (S109). It should be noted that the control unit 10 may carry out a process which shows an image of the title on the display 50 along with the process which acoustically reproduces the title if a vehicle is stopping, for example.

After the read out of the title portion, the control unit 10 resumes the process which acoustically reproduces the tourist guidance from the speaker 40 (S110). It should be noted that, upon the resumption of the process which reproduces the content sounds in the S110, the control unit 10 may resume the acoustic reproduction of the tourist guidance prior to a portion which was being reproduced upon the suspension, specifically a beginning of a paragraph before the portion which was being reproduced upon the suspension. As a result, even if the reproduction of the sounds of the tourist guidance is suspended, the user can easily recognize what the content implies.

On the other hand, if the speech recognizing engine 16 determines that the speech recognition result does not receive any hits from the readout-specific speech recognition dictionary, namely, the speech recognition result is not “title” in the step S107, the speech recognizing engine 16 deploys an incorporated conventional speech recognition dictionary (S111). The speech recognizing engine 16 further searches the conventional speech recognition dictionary for the speech recognition result obtained in the step S103 (S112).

The control unit 10 then carries out a process corresponding to the speech recognition result (S113). For example, if the speech recognition result is “present location”, the control unit 10 carries out a process which reads character information corresponding to a present location, and produces a speech pattern reciting the character information from the speaker 40. If the speech recognition result is “destination”, the control unit 10 carries out a process which reads character information corresponding to a destination, generates a speech pattern reciting the character information from the speaker 40, and shows a map image in a vicinity of the destination on the display 50.

In this way, if the speech switch 20 is depressed during the acoustic reproduction of a tourist guidance, which is a content, the content providing device 100 recognizes a speech pattern collected by the microphone 30, suspends the process which acoustically reproduces the tourist guidance if the speech recognition result is “title”, and carries out the process which reads a title within content-relevant information included in content data, and acoustically reproduces the title. Thus, the tourist guidance can be acoustically reproduced as well as the title of the tourist guidance, and the user can easily and quickly review the title of the tourist guidance. Moreover, since the acoustic reproduction of the tourist guidance is suspended while the title of the tourist guidance is being acoustically produced, the user easily listens to the speech pattern reciting the title of the desired tourist guidance.

It should be noted that although the control unit 10 suspends the process which reproduces content sounds when the readout control section 12 carries out the process which reads a title of a content according to the above embodiment, the control section 10 may carry out a process which reduces a volume of the content sounds. With this configuration, the user can also easily listen to the speech pattern reciting the title of the content. Alternatively, if readout of a title is instructed immediately before the end of a reproduction of content sounds, a title may be read after the end of the reproduction of the content sounds and subsequently acoustically reproduced.

Although there is provided the configuration that after the user depresses the speech switch 20, readout of a title of a content is instructed based upon a speech pattern collected by the microphone 30 according to the above embodiment, an operation key 60 is provided to instruct readout as in a content providing device 200 shown in FIG. 5, and if the user depresses the key during a production of content sounds, a title of a content may be read, or a screen of the display 50 may be configured as a touch panel, and if the user touches a predetermined position of the screen, the title of the content may be read and subsequently acoustically reproduced.

Although a description given of the above embodiment for the case where a title is read as relevant information of a tourist guidance, various types of information relating to tourist facilities such as a facility name may be read and acoustically reproduced as the relevant information of the tourist guidance. In this case, the content-relevant information includes the various types of information relating to the tourist facilities, and the readout-specific speech recognition dictionary includes information corresponding to “tourist facility”, which is a speech pattern to be recognized. Then, if a recognition result of the speech of the user is “tourist facility” or the like while sounds reciting a tourist facility are being reproduced, the content providing device 100 suspends the acoustic reproduction, and reads and acoustically reproduces various types of information relevant to the tourist facility such as a facility name.

Moreover, the present invention may be applied to presentation of various contents in addition to the tourist guidance. For example, if the content providing device 100 includes a function to provide location information, the content providing device 100 can read and acoustically reproduce location information, and can read and acoustically reproduce location information such as an address, a zip code, and a telephone number of the location, as well as various types of information relevant to the location information, such as date and time of the creation of the location information. In this case, the content-relevant information includes various types of information relating to the location information, and the readout-specific speech recognition dictionary includes information corresponding to “address”, “telephone number”, and the like which are speeches to be recognized. Then, if a recognition result of the speech of the user is “address” or the like while sounds of location information are being reproduced, the content providing device 100 suspends the acoustic reproduction, and reads and acoustically reproduces various types of information relating to the location information such as an address.

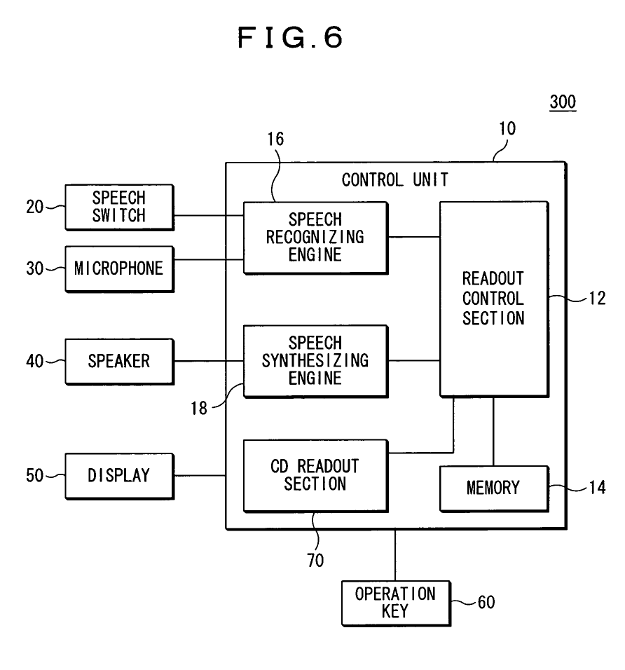

Further, when a content is music recorded on a compact disc (CD), a CD readout section 70 is provided within the control unit 10 as in a content providing device 300 shown in FIG. 6.

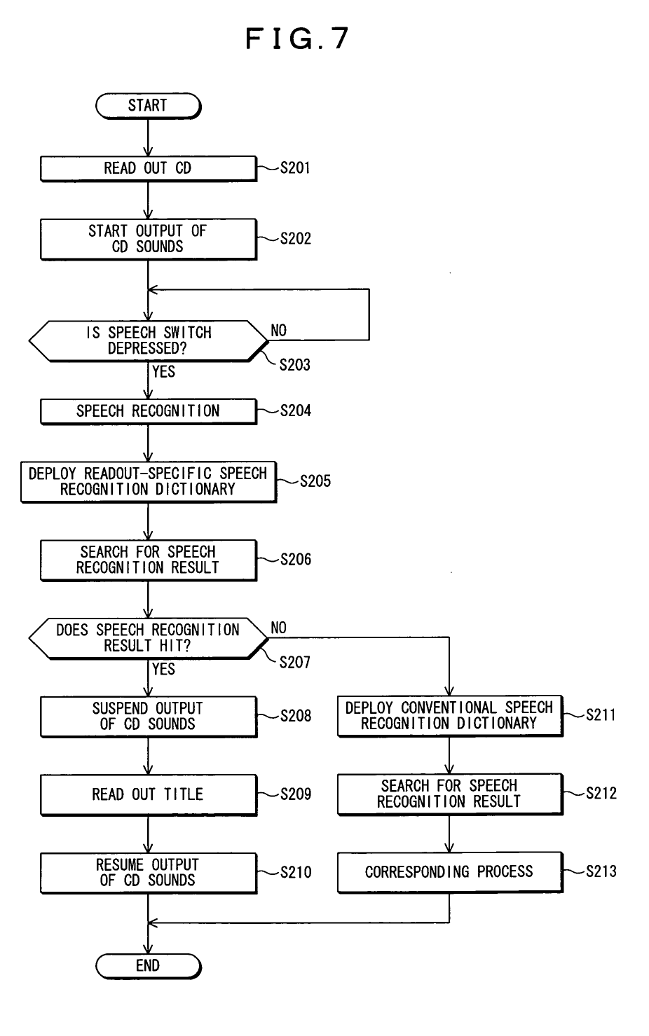

FIG. 7 is a flowchart showing the operation of the content providing device 300. The CD readout section 70 within the control unit 10 starts a process which reads content data stored in a CD (S201), and reproduces CD sounds from the speaker 40 (S202). Content-relevant information within the content data includes title information of the CD. It should be noted that the content providing device 100 may make a connection to an external server by means of wireless communication, and may obtain the title information which is the content-relevant information.

There is then carried out an operation similar to that in the steps S103 to S107 in FIG. 3. Namely, the control unit 10 determines whether the speech switch 20 is depressed or not (S203), and if the speech switch 20 is depressed, the speech recognizing engine 16 recognizes a speech pattern collected by the microphone 30 (S204). The speech recognizing engine 16 then deploys an incorporated readout-specific speech recognition dictionary (S205), searches for the speech recognition result obtained in the step S204 (S206), and determines whether the speech recognition results in a hit from the readout-specific speech recognition dictionary or not (S207). The readout-specific speech recognition dictionary includes information corresponding to “title” which is a speech pattern to be recognized.

If the speech recognition result hits in the readout-specific speech recognition dictionary, the control unit 10 suspends the process which reproduces the CD sounds from the speaker 40 (S208). It should be noted that the control unit 10 may determine whether the operation key 60 is depressed or not, and may suspend the process which reproduces the CD sounds if the operation key 60 is depressed in place of the steps S203 to S207. The readout control section 12 then reads title information within content-relevant information included in the content data based upon which the CD sounds are reproduced, and the speech synthesizing engine 18 carries out a process which synthesizes a speech pattern corresponding to this readout process, and reproduces the synthesized speech pattern from the speaker 40 (S209). The control unit 10 then resumes the process which reproduces the CD sounds from the speaker 40 (S210). On this occasion, the content providing device 100 may resume the reproduction from a point of the suspension, or may resume the reproduction before the point of the suspension.

On the other hand, if the speech recognizing engine 16 determines that the speech recognition result does not receive a hit from the readout-specific speech recognition dictionary in the step S207, an operation similar to that from the steps S111 to S113 in FIG. 3 is carried out. Namely, the speech recognizing engine 16 deploys an incorporated conventional speech recognition dictionary (S211), and searches for the speech recognition result obtained in the step S203 from the conventional speech recognition dictionary (S212). The control unit 10 then carries out a process corresponding to the speech recognition result (S213).

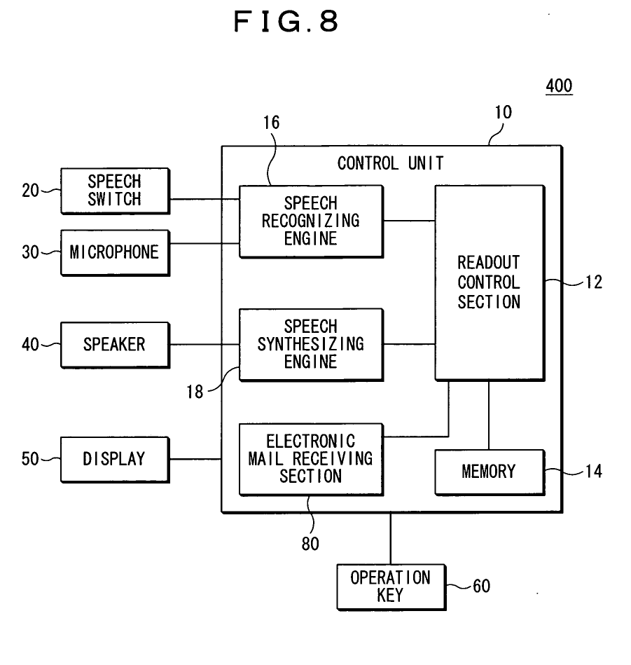

When a content is a body of an electronic mail, an electronic mail receiving section 80 is provided within the control unit 10 as in a content providing device 400 shown in FIG. 8.

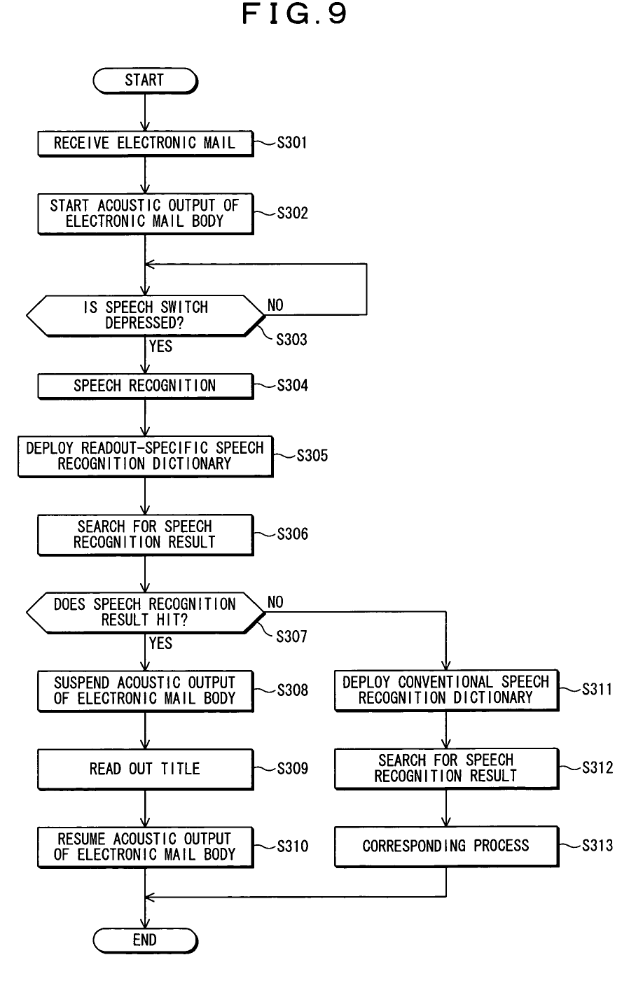

FIG. 9 is a flowchart showing the operation of the content providing device 400. The electronic mail receiving section 80 within the control unit 10 receives an electronic mail as content data (S301), and starts a process which acoustically reproduces a body of the electronic mail from the speaker 40 (S302). The electronic mail which is the content data includes title information as content-relevant information.

There is then carried out an operation similar to that in the steps S103 to S107 in FIG. 3. Namely, the control unit 10 determines whether the speech switch 20 is depressed or not (S303), and if the speech switch 20 is depressed, the speech recognizing engine 16 recognizes a speech pattern collected by the microphone 30 (S304). The speech recognizing engine 16 then deploys an incorporated readout-specific speech recognition dictionary (S305), searches for the speech recognition result obtained in the step S304 (S306), and determines whether the speech recognition result receives a hit from the readout-specific speech recognition dictionary or not (S307). The readout-specific speech recognition dictionary includes information corresponding to “title” which is a speech pattern to be recognized.

If the speech recognition result receives a hit from the readout-specific speech recognition dictionary, the control unit 10 suspends the process which acoustically reproduces the body of the electronic mail from the speaker 40 (S308). It should be noted that the control unit 10 may determine whether the operation key 60 is depressed or not, and may suspend the process which acoustically reproduces the body of the electronic mail if the operation key 60 is depressed in place of the steps S303 to S307. The readout control section 12 then reads title information within content-relevant information included in the electronic mail, which is the content data, based upon which the body of the electronic mail is acoustically reproduced, and the speech synthesizing engine 18 carries out a process which synthesizes a speech pattern corresponding to this readout process, and reproduces the synthesized speech pattern from the speaker 40 (S309). The control unit 10 then resumes the process which acoustically reproduces the body of the electronic mail from the speaker 40 (S310).

On the other hand, if the speech recognizing engine 16 determines that the speech recognition result does not receive a hit from the readout-specific speech recognition dictionary in the step S307, an operation similar to that from the steps S111 to S113 in FIG. 3 is carried out.

It should be noted that the content-relevant information may include various types of information relating to the electronic mail such as a sender, time and data of reception, and presence of an attachment, the readout-specific speech recognition dictionary may be caused to include information corresponding to them, and if a result of the speech recognition carried for the user is “sender” or the like when the content providing device 100 is acoustically reproducing the body of the electronic mail, the acoustic reproduction may be suspended, and the various types of information relating to the electronic mail such as the sender may be read and acoustically reproduced.

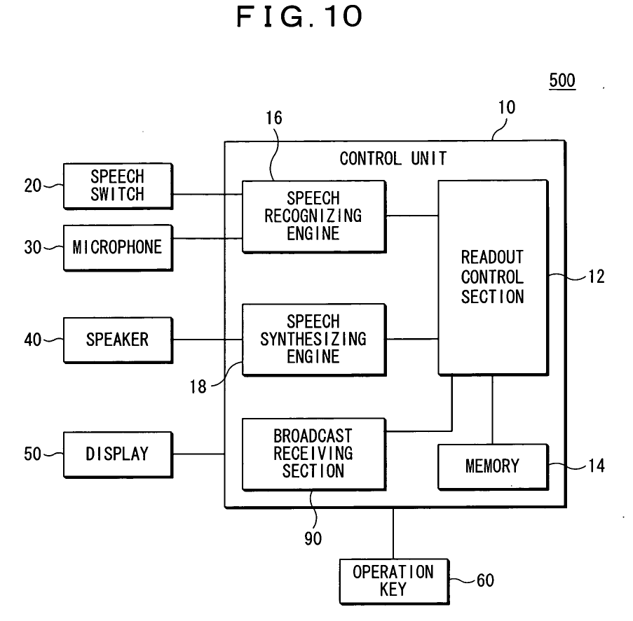

When a content is a broadcast for a television receiver or a radio receiver, a broadcast receiving section 90 is provided within the control unit 10 as in a content providing device 500 shown in FIG. 10.

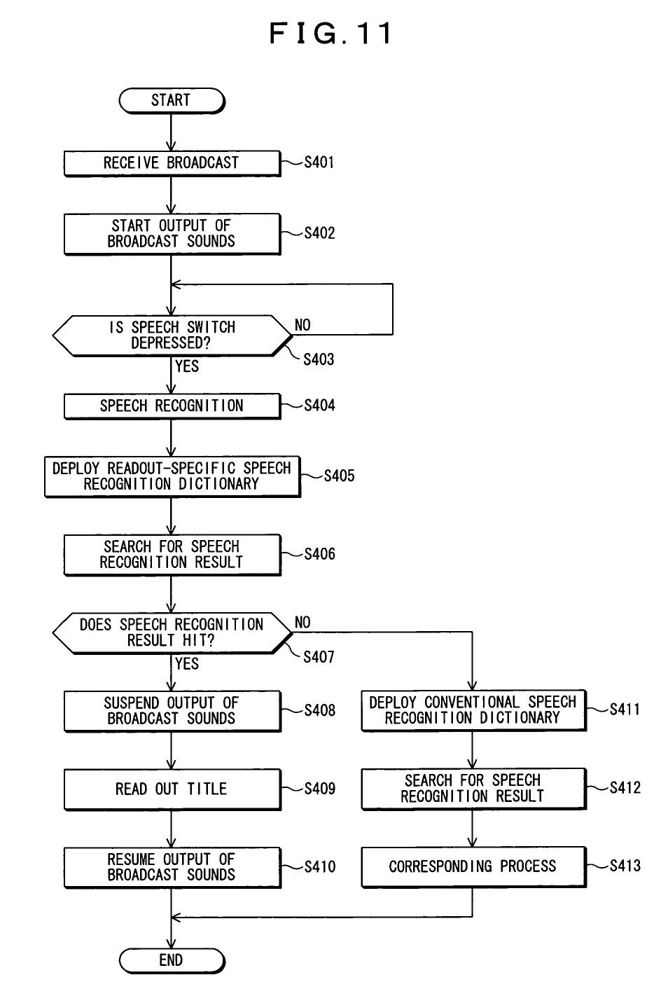

FIG. 11 is a flowchart showing the operation of the content providing device 500. The broadcast receiving section 90 within the control unit 10 receives broadcast data as content data (S401), and starts a process which reproduces broadcast sounds from the speaker 40 (S402). The broadcast data which is the content data includes video and audio, which are the content itself, as well as title information as content-relevant information.

There is then carried out an operation similar to that in the steps S103 to S107 in FIG. 3. Namely, the control unit 10 determines whether the speech switch 20 is depressed or not (S403), and if the speech switch 20 is depressed, the speech recognizing engine 16 recognizes a speech pattern collected by the microphone 30 (S404). The speech recognizing engine 16 then deploys an incorporated readout-specific speech recognition dictionary (S405), searches for the speech recognition result obtained in the step S404 (S406), and determines whether the speech recognition result receives a hit from the readout-specific speech recognition dictionary or not (S407). The readout-specific speech recognition dictionary includes information corresponding to “title” which is a speech pattern to be recognized.

If the speech recognition result receives a hit from the readout-specific speech recognition dictionary, the control unit 10 suspends the process which reproduces the broadcast sounds from the speaker 40 (S408). It should be noted that the control unit 10 may determine whether the operation key 60 is depressed or not, and may suspend the process which reproduces the broadcast sounds if the operation key 60 is depressed in place of the steps S403 to S407. The readout control section 12 then reads title information within content-relevant information included in the broadcast data, which is the content data, based upon which the broadcast sounds are reproduced, and the speech synthesizing engine 18 carries out a process which synthesizes a speech pattern corresponding to this readout process, and reproduces the synthesized speech from the speaker 40 (S409). The control unit 10 then resumes the process which reproduces the broadcast sounds from the speaker 40 (S410).

On the other hand, if the speech recognizing engine 16 determines that the speech recognition result does not receive a hit from the readout-specific speech recognition dictionary in the step S407, an operation similar to that from the steps S111 to S113 in FIG. 3 is carried out.

As described above, the content providing devices according to the present invention enable easy and quick review of relevant information of contents, and thus are useful as content providing devices.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A content providing device comprising:
a processing section operable to execute a process of presenting a content; and
a reading section that reads and acoustically reproduces relevant information describing the content during the execution of the process of presenting the content by the processing section.

2. The content providing device according to claim 1, further comprising:
an instructing section operable to instruct the reading section to read the relevant information of the content, wherein:
the reading section reads and acoustically reproduces the relevant information describing the content according to an instruction received from the instructing section.

3. The content providing device according to claim 1, further comprising:
a speech recognizing section operable to recognize a speech pattern, wherein:
the reading section reads and acoustically reproduces relevant information describing the content relating to the speech pattern recognized by the speech recognizing section.

4. The content providing device according to claim 1, wherein: the processing section suspends the process of presenting the content while the reading section is reading and acoustically reproducing the relevant information describing the content.

5. The content providing device according to claim 4, wherein:
the processing section resumes the process of presenting content at a first portion in the content located prior to a second portion in the content which was being presented upon the suspension.

6. The content providing device according to claim 1, wherein:
the processing section is operable to reduce a sound volume associated with the process while the reading section is reading and acoustically reproducing the relevant information describing the content.

7. The content providing device according to claim 1, further comprising:
a display section operable to display an image corresponding to the relevant information of the content while the reading section is reading and acoustically reproducing the relevant information describing the content.

8. The content providing device according to claim 1, wherein:
the processing section is operable to execute a process of presenting a content on a navigation device; and
the reading section reads and acoustically reproduces title information of the content stored within the navigation device.

9. The content providing device according to claim 8, wherein:
the content presented with the navigation device is a tourist guidance information.

10. The content providing device according to claim 8, wherein:
the content presented with the navigation device is location information.

11. The content providing device according to claim 10, wherein:
the reading section reads and acoustically reproduces at least one of a facility name, an address, a zip code, a telephone number, and date and time of creation of information.

12. The content providing device according to claim 1, wherein:
the content is recorded in a recording medium; and
the reading section reads and acoustically reproduces title information of the content recorded in the recording medium.

13. The content providing device according to claim 1, wherein:
the content is a body of an electronic mail within an electronic mail receiving device; and
the reading section reads and acoustically reproduces at least one of a title, a sender, date and time of reception, and a presence of an attachment of the electronic mail.

14. The content providing device according to claim 1, wherein:
the content is a broadcast received by a broadcast receiving device; and
the reading section reads and acoustically reproduces a title of the broadcast.

15. A content providing method comprising:
carrying out a process of presenting a content; and
reading and acoustically reproducing relevant information describing the content during the process of presenting the content.

16. The content providing method according to claim 15, further comprising:
recognizing a speech pattern; and
reading and acoustically reproducing relevant information describing the content relating to the recognized speech pattern.

17. The content providing method according to claim 15, further comprising:
suspending the process of presenting the content while the relevant information describing the content is being read and acoustically reproduced.

18. The content providing method according to claim 15, further comprising:
reducing a sound volume associated with the process of presenting the content while the relevant information describing the content is being read and acoustically reproduced.

19. A content providing method comprising:
carrying out a process of presenting a content via a navigation device; and
reading and acoustically reproducing title information associated with the content presented by the navigation device during the execution of the process of presenting the content.

20. A content providing method comprising:
carrying out a process of presenting a content recorded in a recording medium; and
reading and acoustically reproducing title information of the content recorded in the recording medium during the execution of the process of presentation of the content.
